(19) United States
(12) Patent Application Publication
(10) Pub. No.: US 2002/0087563 A1
(43) Pub. Date: Jul. 4, 2002

(54) System and method for reorganizing data storage in accordance with usage frequency

(76) Inventors: Sanjay Ghemawat, Mountain View, CA (US); Jeffrey Dean, Menlo Park, CA (US); Mark T. Vandervoorde, Sunnyvale, CA (US)

Correspondence Address: Pennie & Edmonds, LLP, 3300 Hillview Avenue, Palo Alto, CA, 94304, US

(21) Appl. No.: 09/753,908

(22) Filed: Jan. 2, 2001

(51) Int. Cl. G06F 7/00

(52) U.S. Cl. 707/100

(57) ABSTRACT

A system and method for co-localizing temporally accessed data is provided. In one embodiment, objects having a plurality of fields are reorganized. A subset of the fields in an object are each associated with an access frequency that is determined by the number of times the corresponding field is referenced by a program module. The fields within an object are periodically reorganized to form a reorganized object in which frequently accessed fields are co-localized. Further, references to the object in the calling program are updated to properly reference the reorganized object. In another embodiment, objects in a memory that are temporally accessed by a program module are identified as temporally accessed groups. Each temporally accessed group is transferred to a destination space and marked. Then, in a Cheney-style approach, objects that comprise the program roots of the program module are transferred to the destination space. A forwarding pointer is placed in the source space instance of each object transferred to destination space. Each unmarked object in destination space is searched for references to objects in source space. When such an object is found, it is transferred to destination space and unmarked. The search of destination space repeats until all unmarked objects in destination space have been searched.

The present invention relates generally to a system and method for reorganizing data structures so that data that is temporally referenced by a program module is co-localized in memory.

### BACKGROUND OF THE INVENTION

Since 1980, microprocessor performance has improved, on average, about sixty percent per year, while memory access time has only decreased by about ten percent per year. The discrepancy between improved microprocessor performance and memory access time has led to a large processor-memory imbalance. Presently, there is almost a two order magnitude discrepancy between processor performance and memory access time. To address this memory latency problem, a variety of hardware and software techniques, including prefetching, multithreading, non-blocking caches, dynamic instruction scheduling, and speculative execution have been developed. These techniques do not fully address the processor-memory imbalance, however, because they do not remedy the underlying memory latency problem. Further, such techniques often require complex hardware and compilers. Even with appropriate tools, such techniques have proven ineffective for many programs.

A common approach to addressing the memory latency problem has been to use a high speed cache to store data that is frequently accessed by a central processing unit. Caches by themselves, however, do not solve a major cause of memory latency, which is the problem of poor reference locality. Poor reference locality arises when data stored by the cache becomes polluted with data that is infrequently referenced. When this occurs, the cache will be unable to store a satisfactory amount of frequently referenced data and the cache miss frequency will become unacceptably large. The advent of computer object oriented programming languages has made the problem of poor reference locality even more acute because such languages create many objects that quickly become dead because they are no longer referenced by the calling program. If such objects are not periodically discarded from memory, memory is wasted and worse still, precious cache space becomes polluted with dead objects.

To improve reference locality, prior art methods have combined techniques designed to identify and discard dead objects with cache-conscious data placement techniques. See, e.g., Chilimbi and Larus, Using Generational Garbage Collection to Implement Cache-Conscious Data Placement, International Workshop on Memory Management, 1998. In Chilimbi, cache-conscious data placement is combined with Cheney style garbage collection. While functional, the methods of Chilimbi are unsatisfactory because too many dead objects are preserved and the methods are difficult to implement, have high overhead, and are limited in application. Furthermore, prior art cache-conscious data placement techniques do not provide a method for reorganizing fields within a single object so that the frequently addressed fields in the object are co-localized to the same cache line.

Accordingly, it is an object of the present invention to provide a system and method for cache-conscious data placement using low overhead techniques that are capable of co-localizing temporally accessed data to the same or proximate cache line.

### SUMMARY OF THE INVENTION

In one embodiment, the present invention provides a method for reorganizing a data structure type that includes a plurality of fields, each field having a corresponding offset value. An access frequency is associated with each field of at least a subset of the fields in the data structure type. Each access frequency is determined by the number of times that the field associated with the access frequency is referenced. Then, the fields are reordered based on the access frequencies. The reordering of the fields results in a reordered data structure type. Finally, memory references in a program to the data structure type are transformed so that they conform to the reordered data structure type.

In another embodiment, the data structure type may be reordered into at least two data substructure types, including a first data substructure type and a second data substructure type. The first data substructure type includes a pointer that references the second data substructure type, and so forth. In such embodiments, more frequently accessed fields are placed in the first data substructure type. In one aspect of the invention, substructures of the first type are grouped together in memory so that cache lines are not polluted with infrequently referenced data substructures of the second type.

In another aspect of the invention, the number of times that a field in a data structure type is referenced is determined by periodically polling a counter. In one embodiment, this counter is associated with a program memory reference that references the particular field of interest. The counter is incremented each time the memory reference is used to reference the field. In another aspect of the invention, the number of times that a field in the data structure type is referenced is determined by interrupting a program that references instances of the data structure type and simulating the execution of a number of program instructions. The number of times the field was referenced in the simulation is used to calculate the access frequency of the field.

Another embodiment of the present invention provides a system and method for reorganizing a memory having a source space and a destination space. In this embodiment, sets of objects in source space that are temporally accessed by a program are identified. Each set of temporally accessed objects forms a temporally accessed group. The temporally accessed groups are transferred to respective memory locations in destination space, thus co-localizing objects in each temporally accessed group to proximal regions of memory.

In one aspect of the invention, the system and method for reorganizing a memory has additional features. The transferring step creates a destination space instance of each transferred object, while leaving a source space instance of the transferred object in source space. Further, each destination space instance of an object in a temporally accessed group of objects transferred to destination space is marked. Then, objects referred to by program roots are transferred to destination space from source space, thereby creating destination space instances of such objects. A forwarding pointer is placed in the source space instance of each object transferred to destination space. The forwarding pointer references the corresponding destination space instance of the transferred object. Destination space instances of objects that are not marked are scanned to determine whether they reference a target object in source space. When an unmarked destination object references a target object in source space, the system and method: (i) transfers the target object to destination space when a corresponding instance of the target object is not in destination space already; (ii) modifies the referencing object to reference the destination space instance of the target object; and (iii) unmarks the target object in destination space. Destination space is repeatedly searched for unmarked objects until all objects in destination space other than marked objects, if any, have been scanned for references to source space.

In one embodiment, temporal information about object accesses is gathered by (i) interrupting a program that accesses objects and (ii) creating a buffer that tracks object references by the program. A number of program instructions, beginning at the point in the program at which the program was interrupted, are simulated and, when an object is referenced by the simulation, the embodiment includes: (i) placing a reference to the object in the buffer; and (ii) incrementing, for each possible pair of objects referenced by the buffer, a corresponding object pair counter. Objects pairs that correspond to object pair counters having a count that exceeds a threshold value comprise a temporally accessed group. In embodiments in which the buffer size is fixed, when adding an object reference to the buffer would cause it to overflow, the method includes removing from the buffer the reference to a least recently accessed object.

In another aspect of the invention, temporal object access information is gathered without interrupting and simulating a calling program. Instead, the program is “instrumented” with supplemental instructions so that a buffer that tracks a predetermined number of objects is maintained. When an object is referenced by a program, a reference to the object is placed in the buffer and, for each possible object pair in the buffer, a corresponding object pair counter is incremented. Further, when the buffer includes more than the predetermined number of object references, a least recently accessed object is removed from the buffer. Each objects pair corresponding to object pair counters that have a count exceeding a threshold value comprise a temporally accessed group.

### BRIEF DESCRIPTION OF THE DRAWINGS

Additional objects and features of the invention will be more readily apparent from the following detailed description and appended claims when taken in conjunction with the drawings, in which:

FIG. 1 is a block diagram of a system for guiding data reorganization in accordance with the present invention.

FIG. 2 is a flow chart showing a data object in which data object fields are reorganized in accordance with one embodiment of the present invention.

FIG. 3 is a flow chart showing a data object in which fields within the data object are reorganized into substructure data objects in accordance with another embodiment of the present invention.

FIG. 4 illustrates a class library, in accordance with one embodiment of the present invention, in which data objects have fields and each field has an associated offset value.

FIG. 5 illustrates a memory having co-localized data substructures that include frequently accessed fields (hot) and co-localized data substructures that include infrequently accessed fields (cold), in accordance with one embodiment of the present invention.

FIG. 6A is a flow chart of a first method of reorganizing fields within a set of data structure types. FIG. 6B is a flow chart of a second method of reorganizing fields within a set of data structure types. FIGS. 6C and 6D show to alternate data structures used by the methods of FIGS. 6A and 6B to keep track of field access counts during execution of an application.

FIG. 7A depicts a buffer, in accordance with one embodiment of the invention, that tracks a predetermined number of objects and includes a corresponding object pair counter for each possible object pair tracked by the buffer.

FIG. 7B illustrates a method in which the least recently accessed object is discarded from a buffer and object pair counters are incremented, in accordance with one aspect of the present invention.

FIGS. 8A and 8B depict a flow chart in which temporally accessed objects are co-localized in memory in accordance with one aspect of the present invention.

### DESCRIPTION OF THE PREFERRED EMBODIMENTS

The present invention provides a system and method for reorganizing data. In one embodiment, the present invention provides a method for reorganizing a data structure that includes a plurality of fields. Each field (or at least each field in a subset of the fields) is associated with an access frequency. The access frequency is determined by a number of times that the field associated with the access frequency is referenced by a program. Periodically, the fields are reordered based on the access frequencies, resulting in a reordered data structure in which more frequently accessed fields are co-localized. Each instance in the program that references the reorganized data structure is transformed so that it conforms with the reordered data structure type. In one aspect of the invention, each field in the data object is associated with an offset value and the transformation of the program is accomplished by providing the offset value to each field in the reordered data structure.

The present invention further provides a system and method for reorganizing a memory having a source space and a destination space. In this embodiment, objects in the source space that are temporally accessed by a program are transferred to respective neighboring memory locations in destination space, thus co-localizing them. The transferring step creates a destination space instance of each transferred object, while leaving a source space instance of the transferred object. Further, the destination space instance of each transferred object is marked. Then, objects referred to by the program roots of the program are transferred to the destination space from the source space, thereby creating destination space instances of those objects. Destination space instances of objects that are not marked and that have not been previously scanned are examined to determine whether they reference a target object in source space. When a scanned object references a target object in source space, an instance of the target object is transferred to destination space if an instance of the target object is not already in destination space. Further, the instance of the target object in destination space is unmarked. Destination space is repeatedly searched for unmarked objects until all objects in destination space, if any, have been scanned.

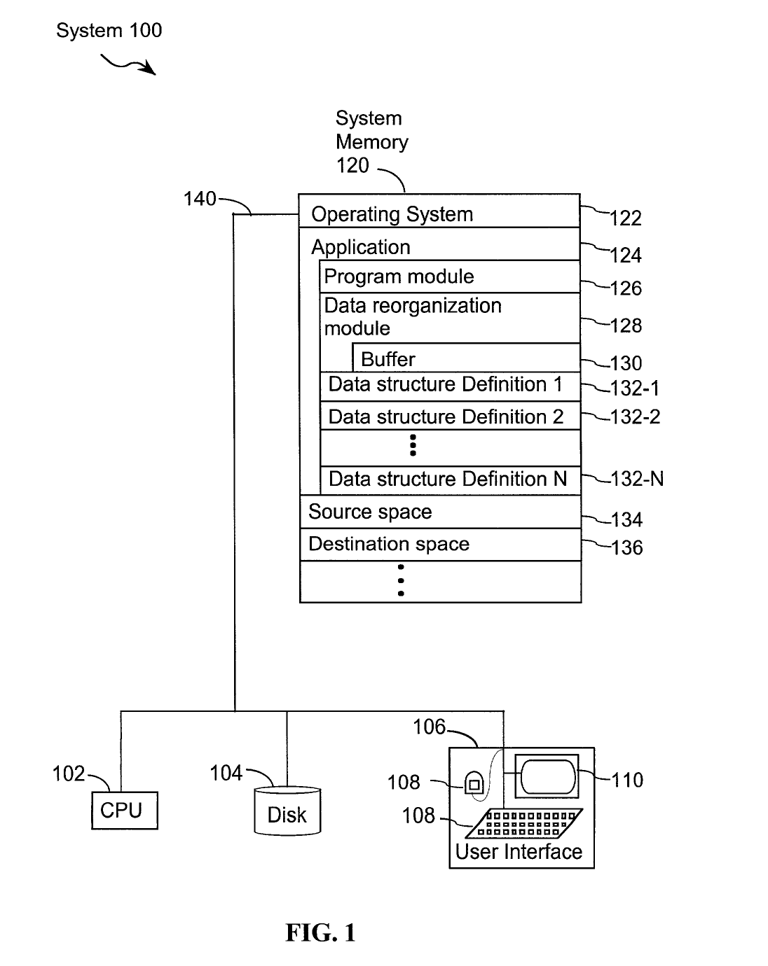

FIG. 1 shows a system, such as system 100, for reorganizing data in accordance with the present invention. The system preferably includes:

a central processing unit 102;

a main non-volatile storage unit 104, preferably a hard disk drive, for storing software and data;

a system memory 120, preferably high speed random-access memory (RAM), for storing system control programs, data, and application programs, including programs and data loaded from disk 104; system memory 120 may also include read-only memory (ROM);

a user interface 106, including one or more input devices 108 and a display 110; and

an internal bus 140 for interconnecting the aforementioned elements of the system.

Operation of system 100 is controlled primarily by the operating system 122, which is executed by central processing unit 102. Operating system 122 may be stored in system memory 120. In a typical implementation, system memory 120 includes:

operating system 122; and

an application 124 that includes a program module 126, a data reorganization module 128 having a buffer 130, and at least one data structure definition (herein also called “data structure types”) 132. In embodiments of the present invention directed to reorganizing a memory, system memory 120 includes a source space 134 and a destination space 136 in which data structure instances are stored.

### Field Reorganization

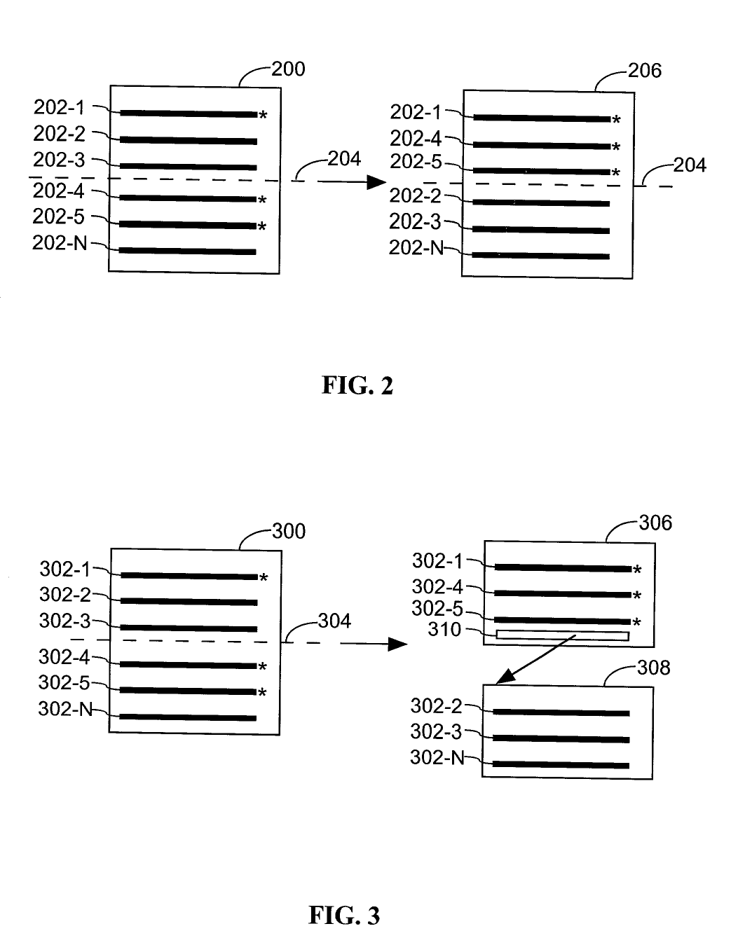

The operation of system 100 will now be described with reference to FIGS. 2-5.

In one embodiment of the present invention, the order of fields in a data structure type are reorganized to co-localize frequently accessed fields. FIG. 2 illustrates a data structure type 200 in accordance with the present invention. Data structure type 200 includes fields 202. In the system and method of the present invention, the frequency that each field 202 is accessed by a program module 126 (FIG. 1) is used to reorder fields 202 (FIG. 2). For example, in FIG. 2, a star notation “*” by fields 202-1, 202-4 and 204-5 indicates that program module 126 accesses these fields more frequently than fields 202-2, 202-3, and 202-N. Accordingly, data structure type 200 is reorganized to form reordered data structure 206 in which fields 202-1, 202-4, and 202-5 are co-localized.

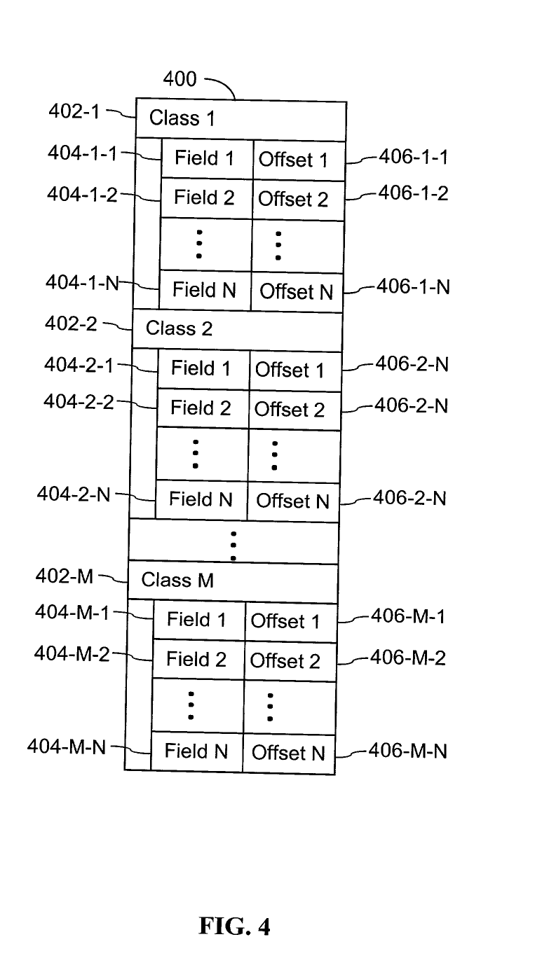

FIG. 3 illustrates another method used to reorganize data structure types in accordance with the present invention. In FIG. 3, the frequency that program module 126 references fields 302 in data structure type 300 is used to split data structure type 300 into data substructure types 306 and 308. In FIG. 3, a star notation by fields 302-1, 302-4, and 302-5 indicates that program control module 126 references these fields more frequently than fields 302-2, 302-3, and 302-N. Accordingly, fields 302-1, 302-4 and 302-5 are placed in data substructure type 306 and fields 302-2, 302-3, and 302-N are placed in data substructure type 308.

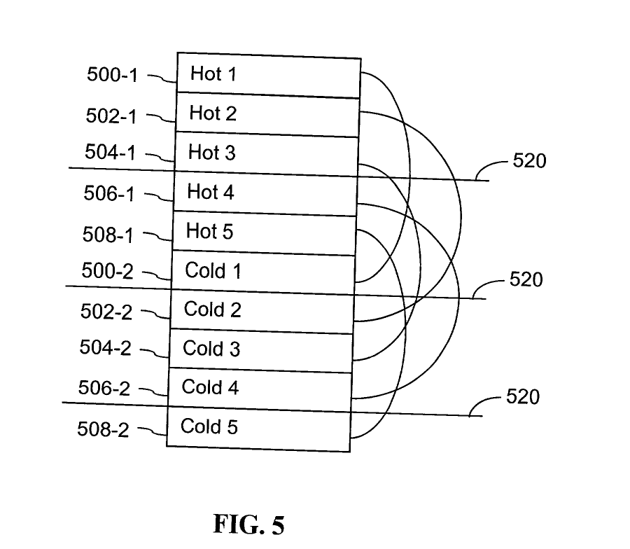

Regardless of whether the reorganized data structure is a single structure, such as reordered data structure type 206 (FIG. 2), or a plurality of data substructure types, such as data substructure types 306 and 308 (FIG. 3), each reference to the original data structure in program module 126 must be transformed to reflect the format of the reorganized data structure. FIG. 4 illustrates one method for tracking field reorganizations in accordance with an embodiment of the present invention. In this embodiment, an offset value 406 is associated with each field 404 in each class 402 in class library 400. The portion of each class 402 shown in FIG. 4 provides a data structure definition, herein called a data structure type. The offset value 406 specifies the current offset of the associated field 404. When the fields 404 of an object class are reorganized, the associated offset values 406 are updated to reflect the new locations of the reorganized fields 404. The updated offset information in class library 400 is used to transform program module 126 (FIG. 1). For example, consider the case in which program module 126 includes the instruction:

a=b·f (1)

where b is an object of class 402 and f is a field 404 in object b. In one embodiment of the present invention, statement (1) is compiled as the instructions:

load rₐ, offset(r_{b})

store offset(r_{b}) (2)

where offset is the associated offset value 406 of field f. When the load command is executed, the offset value 406 associated with field f in the corresponding class 402 is returned. In embodiments of the present invention where a data structure type is split into at least two data substructure types, a second level of indirection is required in program module 126 and additional information needs to be stored in class library 400. Specifically, consider an example where f is a field 302 (FIG. 3) that has been placed in the second data substructure type (308) of FIG. 3. To properly reference f, the pointer 310 to data substructure 308 must be obtained from data substructure 306 before the offset to the field 302 corresponding to f is read. Accordingly, the load statement in (2) will now require an additional load statement to obtain the offset to the second substructure type. Thus, the load statement in (2) will now have the form:

load tmp, offset_to_substructure_308(p)

load rₐ, offset_to_field(tmp) (3)

It will be appreciated that problems may arise by inserting a second load instruction in the compiled code of program module 126. To avoid such problems, in some embodiments in which objects can be reorganized into two substructure types, each load instruction in the originally compiled code is followed with a No Operation (NOP) instruction. Thus, for example, statement (2) will read:

load rₐ, offset(r_{b})

NOP

store offset(r_{b}) (4)

When the object r_{b} is reorganized into two data substructure types, the NOP instruction is replaced by a second load statement as shown in statement (3).

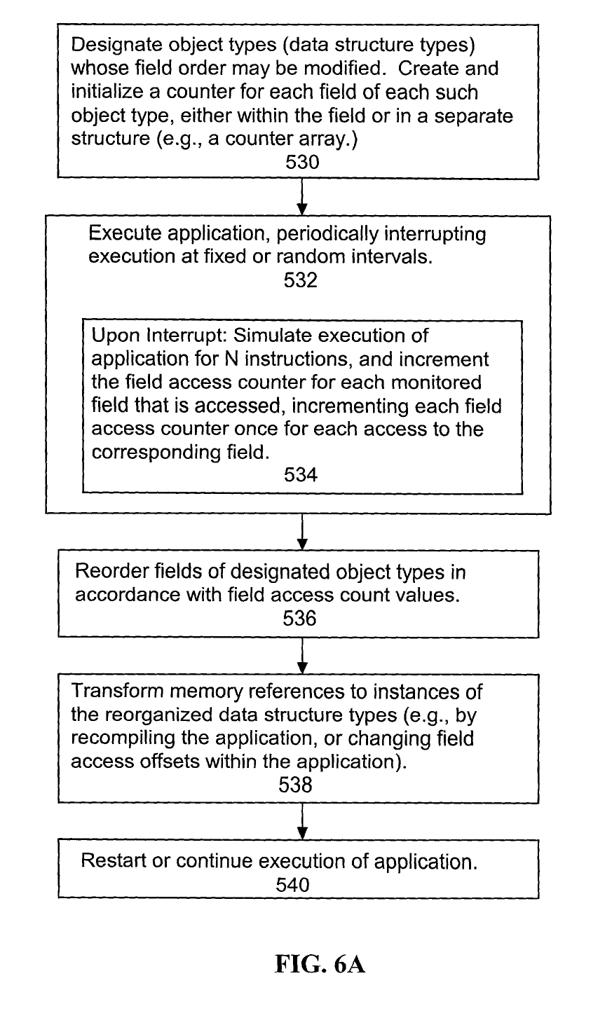

FIG. 5 illustrates the principle that reorganization of data structure types into discrete substructures allows for the co-localization of frequently accessed fields in a cache. In FIG. 5, five objects (500-508) have been reorganized into data substructures of two types, “hot” and “cold.” Thus in FIG. 5, for example, object 502 is split into a hot (502-1) and cold (502-2) substructure. Hot substructures contain frequently accessed fields while the cold substructures contain rarely accessed fields. By co-localizing hot data substructures, cache lines 520 may be populated with frequently accessed data without polluting them with rarely accessed data.

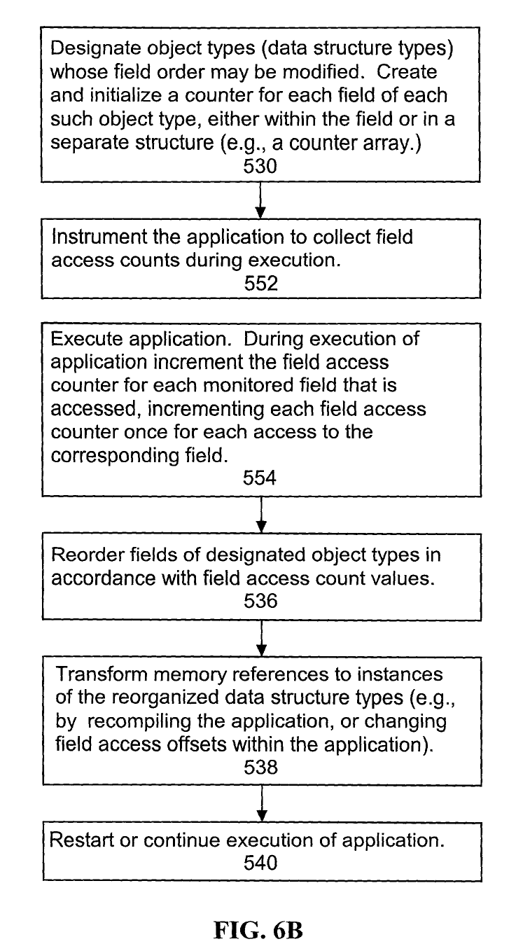

FIG. 6A illustrates a method of reorganizing fields within a set of data structure types, also called object types. This method uses an “interrupt and simulate” methodology to collect object field usage information, while the method shown in FIG. 6B uses an “instrument the application and count field usage during execution” methodology.

Still referring to FIG. 6A, a programmer or other person designates a set of data structure types whose field order may be modified, or most preferably the designation may be made automatically by a compiler, for instance by selecting object types whose size is greater than a particular threshold size (e.g., greater than the size of a cache line). Then a field access counter is created and initialized for each field of each designated data structure type (530). Referring to FIG. 6C, in one embodiment the field access counters are implemented by modifying the data structure type 400 of FIG. 4 to include a distinct counter 408 for each field 404 of each data structure type 402 whose fields may be reorganized. Referring to FIG. 6D, in a second embodiment the field access counters are implemented using a separate array 420 of field access counters 422. Using either implementation, the field access counters 408 or 422 are initial set to a count value of zero.

Next, an application program that uses data structures of the designated data structure types is executed, and that execution is periodically interrupted at either fixed intervals (e.g., every 64,000 instructions) or more preferably random intervals (532). For instance, the application program may be interrupted every Z+rY instructions, where Z is a large constant, such as 64,000, Y is a smaller constant, such as 2,000, and r is a randomly or pseudo-randomly generated number between 0 and 1. Each time the application program's execution is interrupted, the instruction currently being executed is determined, and a simulator is used to simulate continued execution of the application for another N instructions, N is typically a predefined constant such as 500 or 1000. The simulation does not affect the state of the interrupted application. During the simulation, whenever a field of an object of one of the designated data structure types is accessed, a corresponding field access counter is incremented (534).

After execution of the application completes, or alternately after execution of the application has continued for a particular period of time or number of instructions, the fields of the designated data structure types are re-ordered based on the field access counter values (536). The various ways of reorganizing the fields of data structure types was described in detail above and that discussion will not be repeated, except to note that in some cases the fields of a data structure type may not need to be reordered, because the field access count values may indicate that all the highest frequency fields are already located together at the beginning of the data structure type.

Next, memory references to instances of the reorganized data structure types are transformed so as to reference the new locations of the fields, that is the new offsets from the beginning of the data structure instances (538). This transformation may be accomplished in at least two distinct ways: by recompiling the application using the new data structure types, or by changing field access offsets within the previously compiled application. Finally, execution of the application is resumed (if execution was previously halted during reordering of the fields of the designated data structure types and transformation of the corresponding memory references) or restarted, using the reorganized data structure types (540). Execution of the application will be more efficient with respect to cache memory usage after the reorganization because the most frequently used data structure fields will be more likely to be found in cache memory.

FIG. 6B is a flow chart of a second method of reorganizing fields within a set of object types. Only the differences between the first and second methods will be described. The initial step (530) of the first and second methods is the same. However, in this second method, the application program is instrumented with additional instructions immediately before or after every access to any field in any instance of the designated data structure types (552). The fields whose accesses are instrumented in this way are herein called the monitored field. The additional instructions increment the corresponding field access counter. Next, the instrumented application program is executed (554). During execution of the application the field access counter for each monitored field is incremented once for each access to that field (554). Steps 552 and 554 replace steps 532 and 534 of FIG. 6A. Once execution of the instrumented application finished, the remainder of the method is the same as described above. It should be noted that execution of the application is restarted at step 540, it is the un-instrumented application program, with reorganized data structure types, that is executed.

While the term “application program” has been used to indicate the application whose data structure types are reorganized, the methodology of the present invention is also applicable to other types of computer programs, including various types operating system procedures.

While in the Figures discussed above all fields of the designated data structure types are shown as having counters for monitoring field access frequency, in other embodiments it would be possible to monitor a subset of the fields of the designated data structure types. For instance, fields of a particular type (e.g., flags) or having a particular name (e.g., “length”) might not be monitored for access frequency, and thus would not need a corresponding counter because such fields might always be placed near the beginning of the data structure type. Similarly, other types of fields, such as fields whose length is greater than the length of a cache line, might not be monitored because such fields will never be moved to a position closer to the beginning of a data structure object.

### Memory Reorganization During Garbage Collection

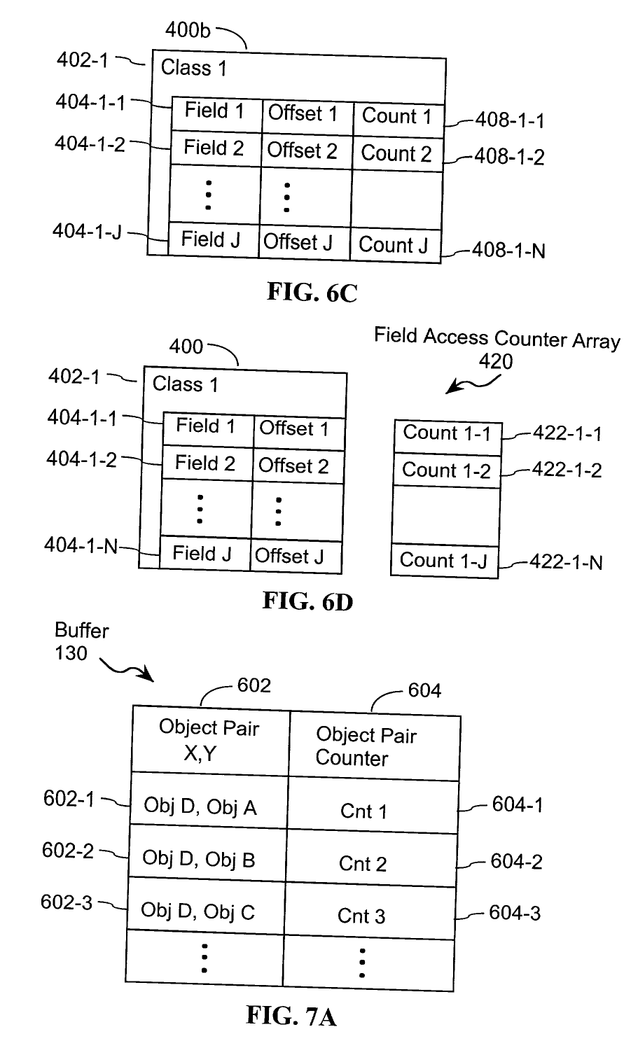

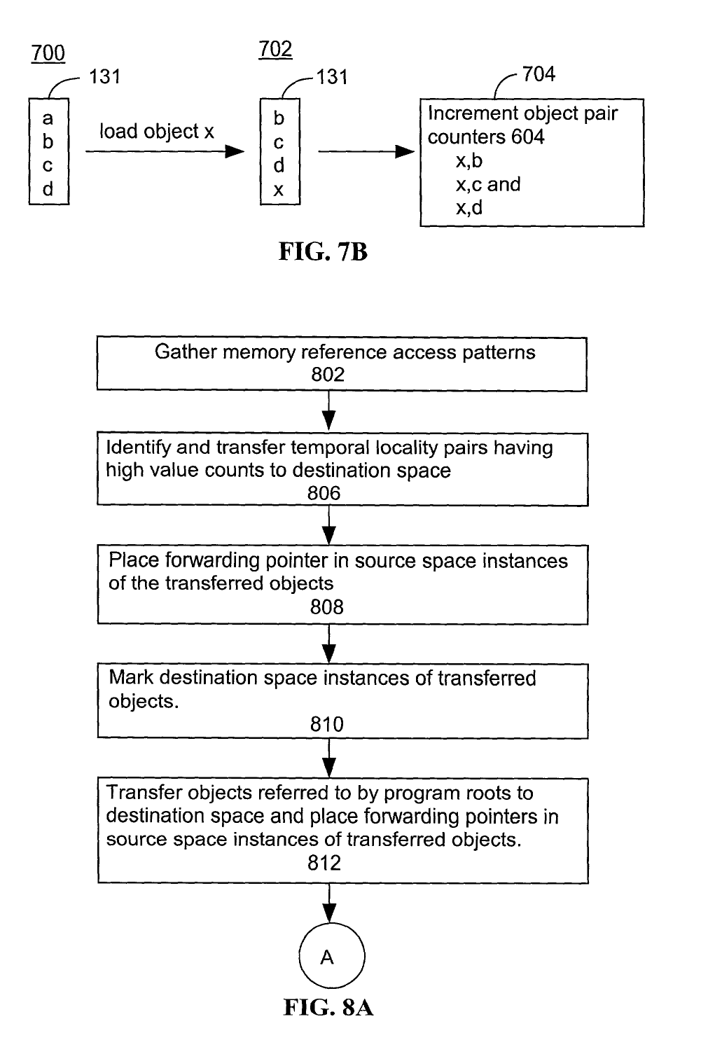

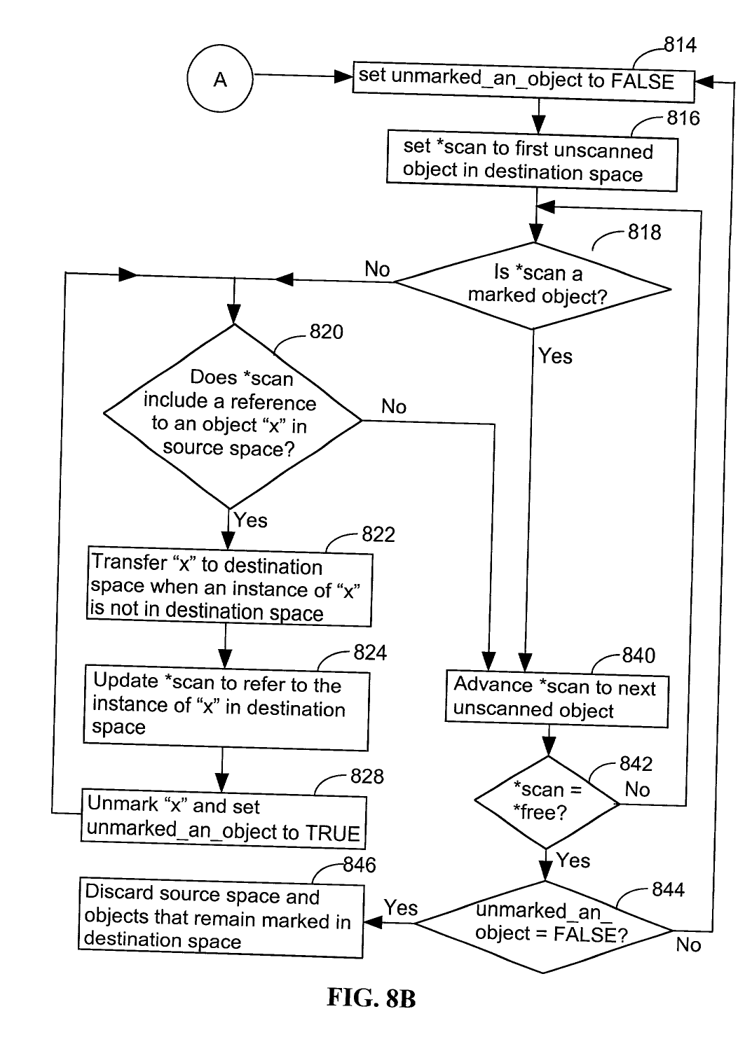

Field reorganization works well for objects that are big compared to cache lines. In contrast, memory reorganization is beneficial over a wide object size range. Memory reorganization requires information about the access pattern of objects in a program or a region of memory. FIGS. 7A, 7B, 8A and 8B show various aspects of one embodiment of the present invention in which the memory reference access patterns of a program are used to identify temporally accessed objects and co-localize them in memory.

One of skill in the art will appreciate that there are a number of different methods by which memory reference access patterns can be determined. In one embodiment, program module 126 (FIG. 1) is interrupted by data reorganization module 128 and a number of instructions in the program are simulated beginning at the point at which program module 126 was interrupted. Each time an object is referenced during the simulation, a corresponding set of object count values stored in buffer 130 (FIGS. 1, 7A) are updated. Furthermore, a buffer 131 (FIG. 7B) is used to store a list of the object ids that correspond to the most frequently referenced objects. Therefore, buffer 131 is updated each time an object is referenced during the simulation as well. In the embodiment described here, buffer 130 tracks a predetermined number of object pairs 602. In an alternate embodiment, buffer 130 is expandable so as to be able to track a variable number of object pairs.

For each object pair, there is a corresponding object pair counter 604 in buffer 130 (FIG. 7A). When an object is referenced during the simulation, the object pair counter 604 for each possible object pair 602 that includes the referenced object is incremented in buffer 130. Furthermore, buffer 131 is updated when the object is referenced so that buffer 131 maintains a list of the most frequently referenced objects. This method is illustrated in FIG. 7B for a buffer 131 that tracks the last four objects referenced by program module 126 during a simulation. In panel 700, buffer 131 is tracking the four most recent objects referenced during the simulation, namely objects a, b, c, and d. By panel 702, object x has been referenced by simulated program module 126 and consequently, the object id that was least recently accessed by simulated program module 126, in this case the object id for object a, is discarded from buffer 131 to make room for the object id for object x. When the id for object x is loaded into buffer 131, all possible object pairs that include object x are incremented in buffer 130. As an illustration, object pairs x,b, x,c, and x,d are incremented (704) in FIG. 7A. When the simulation is terminated, the object pairs having a high object pair count (e.g., above a threshold value, which may be either fixed in advance, or determined dynamically on the basis of the count values in buffer 130) are classified as a temporally accessed group. Each temporally accessed group is transferred to a respective memory location, thus co-localizing objects in each temporally accessed group. In one embodiment, each object pair in buffer 130 is considered a temporally accessed group and is therefore co-localized.

In another embodiment of the present invention, no simulation occurs and access pattern information is obtained by maintaining a buffer that tracks a predetermined number of objects. In this embodiment, the program is “instrumented” with additional code so that whenever an object is referenced by program module 126, a reference to the object is placed in a first buffer if it is not already in the first buffer. This first buffer is analogous to buffer 131 (FIG. 7B). Then, each possible object pair counter in a second buffer that includes the newly referenced object is incremented. This second buffer is analogous to buffer 130 (FIG. 7A). When the newly referenced object is not represented in any of the existing object pairs in the second buffer, object pairs formed by the newly referenced object and the objects represented in the first buffer are added to the second buffer. When the first buffer includes more than a predetermined number of objects, the least recently accessed object is removed from the first buffer. In such embodiments, temporally accessed groups are defined as those objects pairs in the second buffer having an object pair counter with a count that exceeds a threshold value.

FIGS. 8A and 8B show a detailed flow chart of memory reorganization processing steps in accordance with one embodiment of the present invention. The memory reorganization is accomplished as part of a garbage collection process in which accessible objects in source space are transferred to destination space, with the added feature being that temporal locality pairs of objects are moved to neighboring locations in destination space as part of the garbage collection process. The embodiment illustrated in FIGS. 8A and 8B uses Cheney style conventions to describe memory reorganization, in which source space memory 134 (FIG. 1) is reorganized by transferring from source space to destination space 136 (FIG. 1) those objects in source space that are still accessible to the program(s) using the objects stored in memory. In processing step 802, temporal access information is collected using a method, such as those described above. In processing step 804, temporal locality pairs that have a high value count, representing the most frequently referenced objects and which are considered to be temporally accessed groups, are transferred to destination space (806). This transfer involves the creation of an instance of each object in a temporally accessed group in a respective memory location in destination space, thereby co-localizing objects in the temporal locality pair in destination space. In processing step 808, a forwarding pointer that references the corresponding destination space instance of an object is placed in each source space instance of a transferred object. Further, in processing step 810, each destination space instance of a transferred object is marked, for instance by setting a flag in the header of the transferred object.

In processing step 812 (FIG. 8A), objects that are referred to by program roots are transferred to destination space. In one example, the objects that form the roots of program module 126 (FIG. 1) are transferred to destination space. Objects transferred in processing step 812 are treated in a manner similar to the objects transferred in processing step 806. A forwarding pointer is placed in the source space instance of each object that references the corresponding destination space instance of the object. However, destination space instances of objects transferred in processing step 812 are not marked.

When temporally accessed groups (step 806) and program roots (step 812) have been transferred, destination space is scanned in accordance with processing steps 814-846 (FIG. 8B). The scan begins by setting an unmarked_an_object flag to false, thereby indicating that no objects marked in processing step 810 have been unmarked. In processing step 816, the pointer *scan is set to the first unscanned object in destination space. If the object that *scan points is unmarked (818-No), the object that *scan points to is searched for references to objects “x” in source space. When a reference to an object “x” in source space is identified (820-Yes), processing steps 822 thru 828 are performed. In processing step 822, an instance of “x” is transferred to destination space if such an instance of object “x” does not already exist in destination space. In processing step 824, the reference to “x” in the object *scan points to is updated so that the reference is to the instance of “x” in destination space rather than the instance of “x” in source space. In processing step 826, “x” is unmarked and in step 828 the flag unmarked_an_object is set to true. It will be appreciated that processing steps 822-828 are performed for each reference to an object in source space that is found in the object that *scan points to in processing step 820.

In processing step 840, *scan is advanced to the next unscanned object in destination space. Processing step 840 is reached by three possible routes. In the first route, processing step 840 is reached when the object that *scan points to is marked (818-Yes). In the second route, processing step 840 is reached when the object *scan points to does not include a reference to an instance of an object in source space (820-No). In the third route, processing step 840 is reached after processing steps 822 thru 828 have been performed for each object “x” in source space that is referenced by the object that *scan points to in processing step 820 (in which case the object at *scan no longer contains any references to objects in source space).

When *scan has been advanced (840), a check (842) is made to determine if *scan is pointing to *free, which denotes the end of destination space. When *scan is equal to *free (842-Yes), *scan has reached the end of the portion of destination space occupied by object instances. When *scan is not equal to *free (842-No), control is returned to processing step 818. When *scan is equal to *free (842-Yes), a check (844) is made to see if any objects have been unmarked during the scan cycle (steps 814-842) by checking the status of the flag unmarked_an_object. When the flag unmarked_an_object is not equal to false (844-No), the flag is set to false (814) and the scan cycle (steps 814-842) is repeated. When the flag unmarked_an_object is equal to false (844-Yes), temporally accessed objects have been successfully co-localized. Objects in source space are discarded and the process ends (846).

Marked objects in destination space are objects that are no longer accessible, and these objects will be automatically discarded during the next garbage collection cycle, at which time the designations of destination space and source space will be swapped.

### Alternative Embodiments

The present invention can be implemented as a computer program product that includes a computer program mechanism embedded in a computer readable storage medium. For instance, the computer program product could contain the program modules shown in FIG. 1. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method of guiding data reorganization in a data structure type that includes a plurality of fields, each field having an associated offset value, the method comprising:
associating an access frequency with each of at least a subset of said fields, wherein each said access frequency is determined by a number of times that its associated field is referenced;
reordering said plurality of fields based on said access frequencies to form a reordered data structure type; and
transforming a memory reference to said data structure type in a program so that said memory reference conforms to said reordered data structure type.

2. The method of claim 1, wherein said reordering includes changing said offset value associated with at least a subset of said fields.

3. The method of claim 1, wherein said reordering includes:
splitting said data structure type into at least two data substructure types, including a first and a second data substructure type;
determining a set of most frequently accessed fields for the data structure type;
placing the determined set of most frequently accessed fields in said first data substructure type; and
directing a pointer in said first data substructure type to point to said second data substructure type.

4. The method of claim 1, wherein a field in said plurality of fields is capable of storing an access frequency and said associating step includes storing said access frequency in said field.

5. The method of claim 1, wherein said number of times said associated field is referenced is determined by:
incrementing a counter associated with a memory reference in a program when said memory reference references said field; and
polling said counter.

6. The method of claim 1, wherein said number of times each said field in said subset is referenced is determined by:
interrupting a program that references instances of said data structure type;
simulating the execution of a number of program instructions beginning at a point in said program at which said program was interrupted; and
counting a number of times said field was referenced in said simulating step.

7. A method of reorganizing a memory having a source space and a destination space, said method comprising the steps of:
identifying sets of objects in said source space that are temporally accessed by a program, each set of temporally accessed objects forming a temporally accessed group; and
transferring each temporally accessed group to a respective memory location in said destination space so that objects in each said temporally accessed group are proximately located with respect to each other.

8. The method of claim 7, including:
said transferring step creating a destination space instance of each transferred object, while leaving a source space instance of the transferred object in said source space;
marking the destination space instances of the temporally accessed groups of objects transferred to destination space;
transferring objects referred by program roots to said destination space from said source space, thereby creating destination space instances of those objects;
for each object transferred to destination space, placing a forwarding pointer in the source space instance of the transferred object, the forwarding pointer referencing the destination space instance of the transferred object;
selecting and scanning a destination space instance of an object that is not marked and that has not been previously scanned, so as to determine whether said selected object references a target object in said source space and, when said selected object references a target object in said source space, said scanning further comprises:
(i) ensuring that an instance of said target object is in said destination space;
(ii) modifying said selected object to reference said instance of said target object in said destination space; and
(iii) unmarking said instance of said target object in said destination space; and
repeating said selecting and scanning step until all objects in said destination space other than marked objects, if any, have been scanned.

9. The method of claim 7, wherein said identifying step includes: interrupting a program;
creating a buffer that tracks program references to objects;
simulating execution of a number of program instructions beginning at a point in said program at which said program was interrupted; wherein, when an object is referenced by said simulation, said simulating includes:
(i) placing a reference to said object in said buffer; and
(ii) incrementing, for each possible pair of objects referenced by said buffer, a corresponding object pair counter;
wherein, object pairs that correspond to object pair counters having a count that exceeds a threshold value comprise a temporally accessed group.

10. The method of claim 7, wherein said identifying step includes:
interrupting a program;
creating a buffer that tracks a predetermined number of objects;
simulating execution of a number of program instructions beginning at a point in said program at which said program was interrupted; wherein, when an object is referenced by said simulation, said simulating includes:
(i) placing a reference to said object in said buffer;
(ii) incrementing, for each possible pair of objects referenced by said buffer, a corresponding object pair counter; and
(iii) removing the reference to a least recently accessed object from said buffer when said buffer includes references to more than said predetermined number of objects;
wherein, object pairs that correspond to object pair counters having a count that exceeds a threshold value comprise a temporally accessed group.

11. The method of claim 7, wherein said identifying step includes:
maintaining a buffer that tracks program references to objects;
when an object is referenced by a program, placing a reference to said object in said buffer;
incrementing, for each possible object pair in said buffer, a corresponding object pair counter; and
wherein, objects pairs that correspond to object pair counters having a count that exceeds a threshold value comprise a temporally accessed group.

12. The method of claim 7, wherein said identifying step includes:
maintaining a buffer that tracks a predetermined number of objects;
when an object is referenced by a program, placing a reference to said object in said buffer;
incrementing, for each possible object pair in said buffer, a corresponding object pair counter; and
removing a reference to a least recently accessed object from said buffer when said buffer includes more than said predetermined number of object references;
wherein, objects pairs that correspond to object pair counters having a count that exceeds a threshold value comprise a temporally accessed group.

13. The method of claim 8, wherein, for each object transferred to said destination space in said transferring step, the method includes:
identifying a most frequently accessed target object that is referenced by said transferred object; and
determining whether an instance of said target object is in said destination space, wherein, when an instance of said target object is not in said destination space, said target object is transferred from said source space to said destination space and a forwarding pointer is placed in said instance of said object in said source space that references said corresponding object in said destination space.

14. A computer program product for use in conjunction with a computer system, the computer program product comprising a computer readable storage medium and a computer program mechanism embedded therein, the computer program mechanism comprising:
a data structure type definition for defining a data structure type including a plurality of fields, each field having an associated offset value;
a program module that references said data structure type;
a data reorganization module for reorganizing said data structure type, said data reorganization module comprising:
instructions for associating an access frequency with each of at least a subset of said fields, wherein each said access frequency is determined by a number of times that its associated field is referenced by said program module;
instructions for reordering said plurality of fields based on said access frequencies to form a reordered data structure type; and
instructions for transforming a memory reference to said data structure type in said program module program so that said memory reference conforms to said reordered data structure type.

15. The computer program product of claim 14, wherein said instructions for reordering said plurality of fields includes instructions for changing said offset value associated with at least a subset of said fields.

16. The computer program product of claim 14, wherein said instructions for reordering said plurality of fields includes:
instructions for determining a set of most frequently accessed fields for the data substructure type;
instructions for splitting the data structure type into at least two data substructure types, including a first and a second data substructure type;
instructions for placing the determined set of most frequently accessed fields in said first data substructure type; and
instructions for directing a pointer in said first data substructure type to point to said second data substructure type.

17. The computer program product of claim 14, wherein a field in said plurality of fields is capable of storing an access frequency and said instructions for associating an access frequency with each said field includes instructions for storing said access frequency in said field.

18. The computer program product of claim 14, wherein said number of times said associated field is referenced by said program module is determined by instructions encoded in said program module, said instructions including:
instructions for incrementing a counter associated with a memory reference in said program module when said memory reference references said field; and
instructions for polling said counter.

19. The computer program product of claim 14, wherein said instructions for associating an access frequency with each field in said subset of fields includes instructions for determining said number of times each of said fields in said subset are referenced, said instructions comprising:
instructions for interrupting said program module;
instructions for simulating the execution of a number of program instructions beginning at a point at which said program module was interrupted; and
instructions for counting a number of times each of said fields in said subset was referenced in the simulation.

20. A computer program product for use in conjunction with a computer system, the computer program product comprising a computer readable storage medium and a computer program mechanism embedded therein, the computer program mechanism comprising:
a program module for controlling an application, said program module including program roots;
a data reorganization module for reorganizing a memory having a source space and a destination space, said data reorganization module comprising:
instructions for identifying sets of objects in said source space that are temporally accessed by said program module, each set of temporally accessed objects forming a temporally accessed group; and
instructions for transferring each temporally accessed group to a respective memory location in said destination space so that objects in each said temporally accessed group are proximately located with respect to each other.

21. The computer program product of claim 20, wherein said instructions for transferring each temporally accessed group include instructions for creating a destination space instance of each transferred object while leaving a source space instance of the transferred object in said source space, and the data reorganization module includes:
instructions for marking the destination space instances of the temporally accessed groups of objects transferred to destination space;
instructions for transferring objects referred by program roots to said destination space from said source space, thereby creating destination space instances of those objects; and
instructions for placing a forwarding pointer, for each object transferred to destination space, in the source space instance of said transferred object, the forwarding pointer referencing the destination space instance of said transferred object;
instructions for selecting and scanning a destination space instance of an object that is not marked and that has not been previously scanned, so as to determine whether said selected object references a target object in said source space and, when said selected object references a target object in said source space, said scanning further comprises:
(i) instructions for ensuring that an instance of said target object is in said destination space, including creating an instance of said target object in said destination space when an instance of said target object is not already in said destination space;
(ii) instructions for modifying said selected object to reference said instance of said target object in said destination space; and
(iii) instructions for unmarking said instance of said target object in said destination space; and
instructions for repeating said selecting and scanning instructions until all objects in said destination space other than marked objects, if any, have been scanned.

22. The computer program product of claim 20, wherein said instructions for identifying objects that are temporally accessed by said program module include:
instructions for interrupting said program module;
instructions for creating a buffer that tracks program references to objects; instructions for simulating execution of a number of program instructions beginning at a point in said program module at which said program module was interrupted;
wherein, when an object is referenced by said simulation, said simulating includes:
(i) instructions for placing a reference to said object in said buffer; and
(ii) instructions for incrementing, for each possible pair of objects referenced by said buffer, a corresponding object pair counter;
wherein, objects pairs that correspond to object pair counters having a count that exceeds a threshold value comprise a temporally accessed group.

23. The computer program product of claim 20, wherein said instructions for identifying objects that are temporally accessed by said program module include:
instructions for interrupting said program module;
instructions for creating a buffer that tracks a predetermined number of objects;
instructions for simulating execution of a number of program instructions beginning at a point in said program module at which said program module was interrupted;
wherein, when an object is referenced by said simulation, said simulating includes:
(i) instructions for placing a reference to said object in said buffer;
(ii) instructions for incrementing, for each possible pair of objects referenced by said buffer, a corresponding object pair counter; and
(iii) instructions for removing the reference to a least recently accessed object from said buffer when said buffer includes references to more than said predetermined number of objects;
wherein, objects pairs that correspond to object pair counters having a count that exceeds a threshold value comprise a temporally accessed group.

24. The computer program product of claim 20, wherein said instructions for identifying objects that are temporally accessed by said program module includes:
instructions for maintaining a buffer that tracks program references to objects;
instructions for placing a reference to an object in said buffer when said object is referenced by said program module; and
instructions for incrementing, for each possible object pair in said buffer, a corresponding object pair counter;
wherein, objects pairs that correspond to object pair counters having a count that exceeds a threshold value comprise a temporally accessed group.

25. The computer program product of claim 20, wherein said instructions for identifying objects that are temporally accessed by said program module includes:
instructions for maintaining a buffer that tracks a predetermined number of objects;
instructions for placing a reference to an object in said buffer when said object is referenced by said program module;
instructions for incrementing, for each possible object pair in said buffer, a corresponding object pair counter; and
instructions for removing a reference to a least recently accessed object from said buffer when said buffer includes more than said predetermined number of objects object references;
wherein, objects pairs that correspond to object pair counters having a count that exceeds a threshold value comprise a temporally accessed group.

26. The computer program product of claim 21, wherein, for each object transferred to said destination space in said transferring step, said instructions for transferring includes:
instructions for identifying a most frequently accessed target object that is referenced by said transferred object; and
instructions for determining whether an instance of said target object is in said destination space, wherein, when an instance of said target object is not in said destination space, said target object is transferred from said source space to said destination space and a forwarding pointer is placed in said instance of said object in said source space that references said corresponding object in said destination space.

27. A computer system for reorganizing a data structure, the computer system comprising:
a central processing unit;
a memory, coupled to the central processing unit, the memory storing a data structure type definition for defining a data structure type including a plurality of fields, each field having an associated offset value;
a program module, executable by the central processing unit, the program module referencing an instance of said data structure type;
a data reorganization module, executable by the central processing unit, for reorganizing said data structure type, said data reorganization module comprising:
instructions for associating an access frequency with each of at least a subset of said fields, wherein each said access frequency is determined by a number of times that said associated field is referenced by said program module;
instructions for reordering said plurality of fields based on said access frequencies to form a reordered data structure type; and
instructions for transforming a memory reference to said data structure type in said program module program so that said memory reference conforms to said reordered data structure type.

28. The computer system of claim 27, wherein said instructions for reordering said plurality of fields includes instructions for changing said offset value associated with at least a subset of said fields.

29. The computer system of claim 27, wherein said instructions for reordering said plurality of fields includes:
instructions for determining a set of most frequently accessed fields for the data structure type;
instructions for splitting said data structure type into at least two data substructure types, including a first and a second data substructure type;
instructions for placing the determine set of most frequently accessed fields in said first data substructure type; and
instructions for directing a pointer in said first data substructure type to point to said second data substructure type.

30. The computer system of claim 27, wherein a field in said plurality of fields is capable of storing an access frequency and said instructions for associating an access frequency with each said field includes instructions for storing said access frequency in said field.

31. The computer system of claim 27, wherein said number of times said associated field is referenced by said program module is determined by instructions encoded in said program module that include:
instructions for incrementing a counter associated with a memory reference in said program module when said memory reference references said field; and
instructions for polling said counter.

32. The computer system of claim 27, said instructions for associating an access frequency with each field in said subset of fields includes instructions for determining said number of times each of said fields in said subset are referenced, said instructions comprising:
instructions for interrupting said program module;
instructions for simulating the execution of a number of program instructions beginning at a point at which said program module was interrupted; and
instructions for counting a number of times each of said fields in said subset was referenced in the simulation.

33. A computer system for running an application, the computer system comprising:
a central processing unit;
a memory, coupled to the central processing unit, the memory including:
a source space and a destination space;
a program module that references objects in said memory;
a data reorganization module for reorganizing said memory, said data reorganization module comprising:
instructions for identifying sets of objects in said source space that are temporally accessed by said program module, each set of temporally accessed objects forming a temporally accessed group; and
instructions for transferring each temporally accessed group to a different memory location in said destination space so that objects in each said temporally accessed group are proximately located with respect to each other.

34. The computer system of claim 33, wherein said instructions for transferring each temporally accessed group include instructions for creating a destination space instance of each transferred object while leaving a source space instance of the transferred object in said source space, and the data reorganization module includes:
instructions for marking the destination space instances of the temporally accessed groups of objects transferred to destination space;
instructions for transferring objects referred by program roots to said destination space from said source space, thereby creating destination space instances of those objects; and
instructions for placing a forwarding pointer, for each object transferred to destination space, in the source space instance of said transferred object, the forwarding pointer referencing the destination space instance of said transferred object;
instructions for selecting and scanning a destination space instance of an object that is not marked and that has not been previously scanned, so as to determine whether said selected object references a target object in said source space and, when said selected object references a target object in said source space, said scanning further comprises:
(i) instructions for ensuring that an instance of said target object is in said destination space;
(ii) instructions for modifying said selected object to reference said instance of said target object in said destination space; and
(iii) instructions for unmarking said instance of said target object in said destination space; and
instructions for repeating said selecting and scanning instructions until all objects in said destination space other than marked objects, if any, have been scanned.

35. The computer system of claim 33, wherein said instructions for identifying objects that are temporally accessed by said program module include:
instructions for interrupting said program module;
instructions for creating a buffer that tracks program references to objects;
instructions for simulating execution of a number of program instructions beginning at a point in said program module at which said program module was interrupted;
wherein, when an object is referenced by said simulation, said simulating includes:
(i) instructions for placing a reference to said object in said buffer; and
(ii) instructions for incrementing, for each possible pair of objects referenced by said buffer, a corresponding object pair counter;
wherein, objects pairs that correspond to object pair counters having a count that exceeds a threshold value comprise a temporally accessed group.

36. The computer system of claim 33, wherein said instructions for identifying objects that are temporally accessed by said program module includes:
instructions for interrupting said program module;
instructions for creating a buffer that tracks a predetermined number of objects;
instructions for simulating execution of a number of program instructions beginning at a point in said program module at which said program module was interrupted;
wherein, when an object is referenced by said simulation, said simulating includes:
(i) instructions for placing a reference to said object in said buffer;
(ii) instructions for incrementing, for each possible pair of objects referenced in said buffer, a corresponding object pair counter; and
(iii) instructions for removing the reference to a least recently accessed object from said buffer when said buffer includes references to more than said predetermined number of objects;
wherein, objects pairs that correspond to object pair counters having a count that exceeds a threshold value comprise a temporally accessed group.

37. The computer system of claim 33, wherein said instructions for identifying objects that are temporally accessed by said program module includes:
instructions for maintaining a buffer that tracks program references to objects;
instructions for placing a reference to an object in said buffer when said object is referenced by said program module; and
instructions for incrementing, for each possible object pair in said buffer, a corresponding object pair counter;
wherein, objects pairs that correspond to object pair counters having a count that exceeds a threshold value comprise a temporally accessed group.

38. The computer system of claim 33, wherein said instructions for identifying objects that are temporally accessed by said program module includes:
instructions for maintaining a buffer that tracks a predetermined number of objects;
instructions for placing a reference to said object in said buffer when said object is referenced by said program module;
instructions for incrementing, for each possible object pair in said buffer, a corresponding object pair counter; and
instructions for removing a reference to a least recently accessed object from said buffer when said buffer includes more than said predetermined number of object references;
wherein, objects pairs that correspond to object pair counters having a count that exceeds a threshold value comprise a temporally accessed group.

39. The computer system of claim 34, wherein, for each object transferred to said destination space in said transferring step, said instructions for copying objects includes:
instructions for identifying a most frequently accessed target object that is referenced by said transferred object; and
instructions for determining whether an instance of said target object is in said destination space, wherein, when an instance of said target object is not in said destination space, said target object is transferred from said source space to said destination space and a forwarding pointer is placed in said instance of said object in said source space that references said corresponding object in said destination space.
